(19) United States
(12) Patent Application Publication
(10) Pub. No.: US 2018/0305026 A1
(43) Pub. Date: Oct. 25, 2018

(54) Increase the Airline Seat Comfort and Revenue via Track-based Elevated Seat

(71) Applicants: KANG YAO, DELRAY BEACH, FL (US); NAN AN, BOYNTON BEACH, FL (US); YUSI YAO, NANJING (CN)

(72) Inventors: KANG YAO, DELRAY BEACH, FL (US); NAN AN, BOYNTON BEACH, FL (US); YUSI YAO, NANJING (CN)

(73) Assignee: AMERICAN MAGNETIC ENGINEERING, INC., DELRAY BEACH, FL (US)

(21) Appl. No.: 15/492,811

(22) Filed: Apr. 20, 2017

(51) Int. Cl. B64D 11/06

(52) U.S. Cl. CPC B64D 11/0696; B64D 11/064; B64D 11/0644

(57) ABSTRACT

The present invention provides airlines with the track-based elevated seat arrangement for an improved passenger comfort and hence improved revenue. In our track-based elevated seat arrangement design, the multiple seating configurations and mixed class are proposed in a given cabin class of a passenger airplane. It effectively uses the vertical space of the given interior space of the given cabin class and can bring a new level of comfort and fresh flying experience to the passengers in that cabin class.

### BACKGROUND OF THE INVENTION

Today, commercial passenger aircraft is typically equipped with passenger seat-row arrangements including different seat and seat pitches corresponding to the class configuration of the passenger cabins, i.e., first class, business class or economy class in essence. The seat pitch in each class is typically standard for the total number of passengers in a given aircraft. With a smaller seat pitch, a larger number of seat rows can be installed. Due to aerodynamic and weight limits, commercial aircraft generally has a limited interior volume. The limited interior volume further limits available floor space and space for seating. Commercial aircraft is generally configured in a linear configuration of rows and columns of seats. Although many current cabin configurations are sufficient to help commercial operators make adequate revenues while meeting basic passenger need, there is still room to increase the aircraft revenue by providing passengers with an new level of comfort and flying experience. Therefore, a track-based elevated seat arrangement is present with our unique design. In our typical case of new seat arrangement, the left and right side seats of a seat-row stay in the same position unchanged. Meanwhile, the pitch of the elevated seat in the center is increased slightly (by about 5 inches) while its seat height is elevated clearly above that of the adjacent seats on the left and right(by a height difference in the range of 10″ to 42″ inches). The elevated seat incorporates our special maglev module (Yao, patent application Ser. No. 15/359,434. Nov. 22, 2016). The passengers can sit on our maglev module for comfort and can also gain the freedom of safe and modest on-board exercise using the module's coherent elasticity and resistance. These great features are made possible with our present innovation. This is extremely desired for a long-distance flight especially a long-haul international flight.

With this invention, passenger can recline on the elevated seat using the support of its foldable leg resting gear. Passenger can stretch his or her tired body by extending the leg onto the foldable leg support underneath the elevated seat in the front row.

This invention actually increases the personal space for passengers of all seats. Each elevated seat has a wide-angle (up to 140 Degree) reclining seatback and foldable leg rest. With this design, passenger can enjoy the luxury and comfort that is otherwise only available to business class passengers, and all this is affordable to passengers at only a fraction of the cost of the business class, i.e., passengers just need to pay a reasonable upgrading fee to enjoy the flight on the elevated seats.

To accommodate the changing travel and flight pattern of various season, our track-based elevated seat is mounted onto the slide track underneath the floor so that airlines can easily adjust the position of the elevated seat by sliding the it to the desired position and lock it securely, i.e., position for normal seat arrangement (more seating capacity) and position for elevated seat arrangement (more personal space and comfort for passengers). This track-based elevated seat arrangement makes it even more convenient and efficient for airlines to adopt our invention and improve its overall service level and increase the revenue. Here are some major benefits for family or group travelers:

They can stay in the same cabin class (in this case, improved economy class) accompanying each other thanks to the convenience brought by our track-based elevated seat arrangement. Thus, it saves them a great bundle while allowing them to enjoy the special comfort and luxury provided by the elevated seat, which otherwise is only available in the business class with a hefty price tag. That said, our unique track-based elevated seat arrangement can also be applied in the business class or any other cabin class. With this track-based elevated seat arrangement, airlines will be on the right track to gain more passenger approval and revenue per seat.

Compared with above prior art US20150210396 (Luk) i.e., adopting aircraft seat arrangement to increase the maximum number of seats within a small space of given aircraft, our focus is rather on providing extra comfort to passengers on long-distance flight especially the long-haul international flights.

US20120274108 A1 (Kim) discloses that in the airplane seat system, a plurality of seats, each having a seat part, a backrest part, and armrests, are arranged in lines on a pop-up frame and one line of seats is higher than other lines of seats by a predetermined height due to the pop-up platform and said one line is further forward than the other lines of seats by a predetermined distance. This prior art intends to increase the seat height on the continuous protruding platform while ours is a track-based elevated seat system which can be mounted in random position and number with great flexibility (such as seats E5, E6a and E6B shown in FIG. 1a). It can provide more personal space and comfort for all passengers in the cabin class with this new seat arrangement. Setting up the elevated seats by building a platform like that of the prior art may slow down the evacuation speed during an emergency situation because the passengers in a panic have to manage to cross over the protruding platform. Also, a noticeable horizontal gap between the adjacent seats is given in order to accommodate its seat arrangement, which actually trades off some precious space on board. This continuous protruding mounting structure also adds additional weight to the airplane.

Our track-based elevated seat has foldable seat back and foot pedal that enables passenger to move in and out of their seats safely and quickly. Our invention mainly uses the elevation to free up the vertical space to allow adjacent passengers enjoy more personal space, i.e., independent elbow space etc. Our invention is very efficient in space utilization and can provide more personal space and comfort for passengers in the cabin with our new seat arrangement. It is extremely helpful for passengers of the long-distance flight because of the travel-related fatigue and jet lag. By increasing the seat pitch slightly, we can provide much improved comfort and even a chance of the safe on-board exercise for all passengers in the given cabin class as illustrated in FIG. 1a.

U.S. Pat. No. 7,022,050 B2 (The Boeing Company) discloses a detachable treadmill for passengers to exercise on an aircraft, capable of being displaced between stowed and deployed positions. For passengers aboard the aircraft, the seating and treadmill exercise device may be placed in the stowed position to allow passengers to freely move around the aircraft cabin. However, this creates a problem, i.e., lack of sufficient access for most passengers in the cabin. It is risky for passenger to line up waiting in turn to use the treadmill since the airplane may encounter the turbulence during the flight.

With our maglev module incorporated into our track-based elevated seat, most of the passengers can have access to a safe and modest exercise in the space around each seat. The exercise can be practiced in the sitting mode and the standing mode as shown in FIG. 9.

### SUMMARY OF THE INVENTION

The present disclosure describes aircraft cabin with various seating arrangement. For example, Boeing 787 has an economy class passenger cabin with a 3-3-3 seat-row arrangement, with three left outboard seats, three seats between the aisles and three right outboard seats. In our case of the improved economy class, there are originally 63 seats in the configuration of 7 rows and each row with a 3-3-3 seat per row arrangement. The original pitch between the rows is 36 inches. In the complicated case of one row seating arrangement, the left and right seats stay in the same position and occupy the same space. For our track-based elevated seat arrangement, the revised seat pitch for the elevated seat “b” is increased to 41 inches while its adjacent seats remain in original pitch configuration. Based on track-based elevated seat arrangement, the revised seating capacity is reduced to 58 with 38 regular seats and 20 elevated seats. With this new seating arrangement, all passengers will enjoy more space and comfort even for those in the regular seats of each row. This becomes possible because that the elevated seat frees up the vertical space in the seating area and hence the armrests of the adjacent seats are separated from each other which yields more elbow room for each passenger.

Assuming that each business class seat takes up the space of three regular seats, in the same space of improved economy class, only twenty-one business class seats can be arranged. However, for the same class using our seat arrangement, 20 track-based elevated seats and 38 regular seats can be accommodated to provide maximum comfort to all passengers in this class. This adds flexibility to airlines in setting up a new mixed class of seating arrangement, i.e., improved economy class via on track-based elevated seat arrangement.

Here, we like to make a simple calculation to illustrate the revenue advantage of this new seat arrangement:

For the regular seat, its fare is $1C/seat, so the original seat arrangement in the improved economy class will generate the total revenue: $1C/seat×63 seats=$63C.

After adoption of our track-based elevated seat, each seat can provide more space and comfort, which hence generate more revenue, say, the fare for the regular seat will be increased slightly by 10%, the subtotal revenue generated by the 38 regular seats in this class is:

$1C/seat×110%×38 seats=$41.8C

Meanwhile, the fare for the luxury elevated seat is increased modestly by 80% (for reference, the fare of the business class seat is easily 4 times or higher than that of the economy class on long-haul international flight).

The subtotal revenue generated by the 20 elevated seats in this class is:

$1C/seat×180%×20 seats=$36C

So, the total revenue generated by all seats in this improved economy class is:

$41.8C+$36C=$77.8C

Compared with the original total revenue of $63C, there is a significant revenue improvement of 23.5%. That is only for one cabin class, i.e., improved economy class. Therefore the improved airline revenue using to the optimal seating arrangement via track-based elevated seat is an important factor for airlines to consider about.

FIG. 1a shows the overall view of our new seating arrangement via track-based elevated seat in improved economy class. In FIG. 1b, the three left and right outboard seats stay in the same position and occupy in the same seat space and arrangement, the three area seats are staggered with left and right side seats. There is enough space between different seats in the same row. Passengers can easily move in and out of their seats even during an emergency evacuation.

In FIG. 2, the armrests are arranged between two seats of the same row and the passenger on the seat can adjust its height within the vertical space created by the track-based elevated seat. FIG. 3 and FIG. 4 show the passengers of the regular seats stretching their legs under the space created by the adjacent elevated seat. They can use this extra space for comfort and sometimes even for safe and modest exercise using the maglev module under the elevated seat. FIG. 5 shows the track-based elevated seats with an optional foldable foot rest pedal underneath. The passenger sitting behind can recline and stretch his or her foot onto the foot pedal for relaxation and hence better rest during the long-haul flight.

As shown in FIG. 6, the maximum reclined angle of the elevated seat is about 140 degree, while the original seat in this cabin class can only recline a few degrees from the upright position. The extra space created under the elevated seat can also be used for carry-on bag and or other personal items. The armrest of the elevated seat can be adjusted in height, i.e., it can move vertically and lock in position along the side track of the seat back, which provides further freedom for the passengers around it. The elevated seats are also designed with foldable foot pedal and leg rest support which enables passenger to enjoy a relaxed sleep during a long-distance flight. As seen in FIG. 7 and FIG. 8, an elevated seat can be adjusted in position by sliding along the track which is mounted underneath the cabin floor. The track-based elevated is pre-mounted onto a track and can only be adjusted by the airlines. It can be adjusted into the pattern of “improved economy class via track-based elevated seat” and the normal pattern of “3 seats in a row” to meet the different seating capacity requirement of various travel seasons.

In FIG. 9, passengers on the regular seat can practice safe and modest exercise using multi-functional maglev module (Yao, patent pending) to relieve the travel-related fatigue with. Or they can just stretch their legs onto this multi-functional maglev module for comfort and relaxation. The elevated seats are designed so that passengers can freely move in and out of their seats. During an emergency situation, passengers can quickly move out of the seats by folding the seat back and leg pedal and rest gear.

### REFERENCE

1. US20150210396, Jan. 28, 2014-Jul. 30, 2015. Airbus Defense and Space GmbH, Seat arrangement, aircraft cabin as well as armrest and seat or seat group for use therein.

2. US20120274108 A1, Jun. 29, 2012-Nov. 1, 2012. Jong Jin Kim, Airplane Seat System.

3. U.S. Pat. No. 9,359,079 B2, Jul. 10, 2012-Apr. 29, 2014. Frank Matthew Scott, Slider seat for aircraft.

4. U.S. Pat. No. 7,022,050 B2, Dec. 3, 2001-Apr. 4, 2006. Mithra M. K. V. Sankrithi, Seating and treadmill exercise device.

5. US20060060703 A1, Sep. 22, 2004-Mar. 23, 2006. Fong Luk, Three dimensional seating arrangement to increase seating capacity.

6. U.S. Pat. No. 6,260,813 B1, Jan. 10, 2000-Jul. 17, 2001. Newell E Whitcomb, Aircraft seat track anchor fitting.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1a shows an overall view of new seat arrangement via track-based elevated seats in an improved economy class.

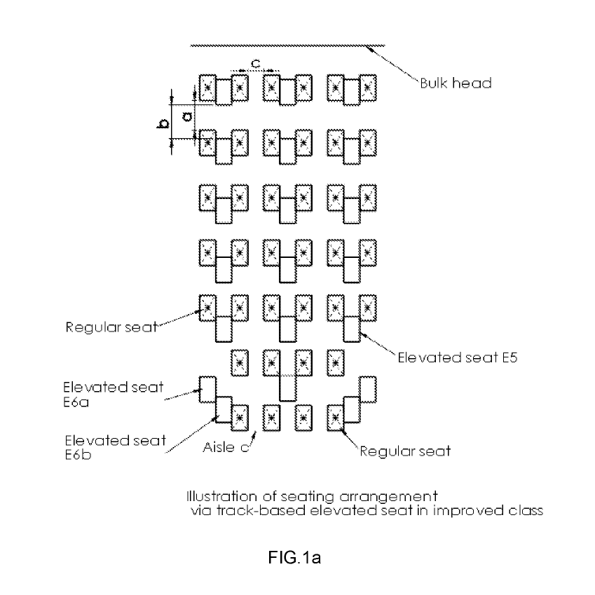

FIG. 1b shows a detailed view of two rows of three-seat arrangement in the new seating arrangement via track-based elevated seats.

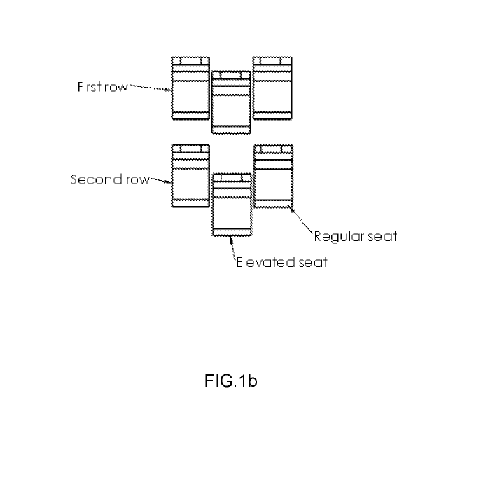

FIG. 2 shows a view of passengers of the new seating arrangement via track-based elevated seats putting their elbows on the armrests that are separated from the armrest of the elevated seats, which create vertical space gap.

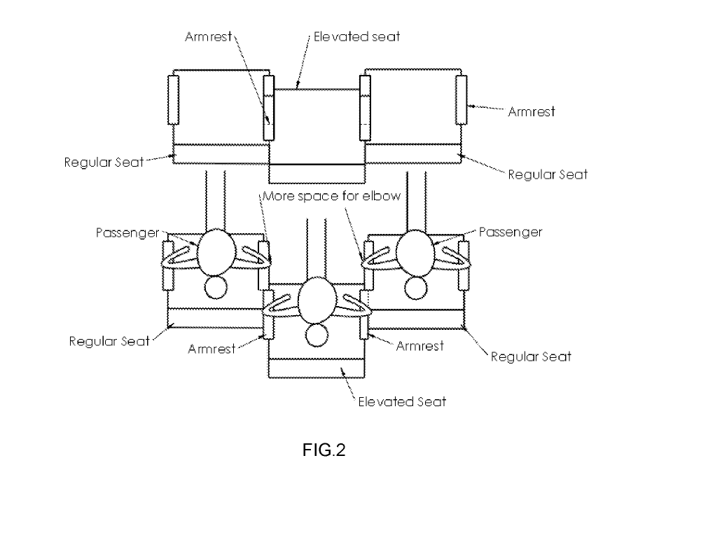

FIG. 3 shows a view of passengers on the adjacent regular seats extending their legs under the extra space below the elevated seat.

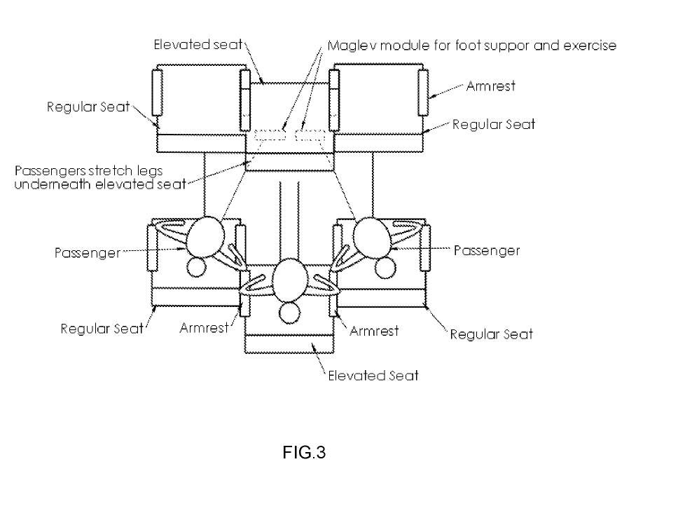

FIG. 4 shows a perspective view of improved foot space under an elevated seat for the adjacent passenger of regular seat

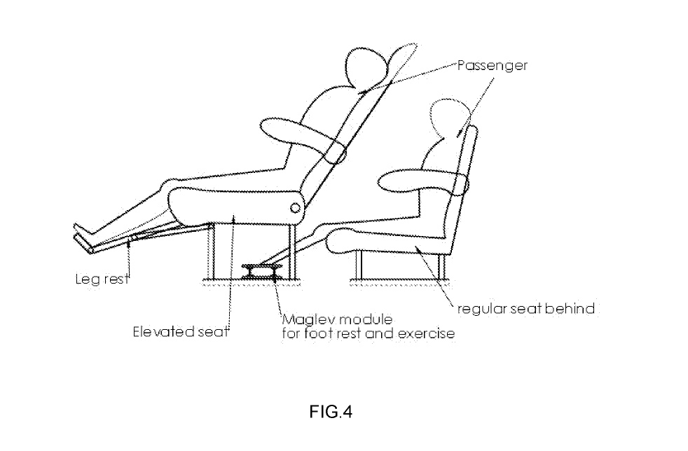

FIG. 5 shows a detail view of optional foot rest pedal under an improved elevated seat to be used by the passenger on the behind seat.

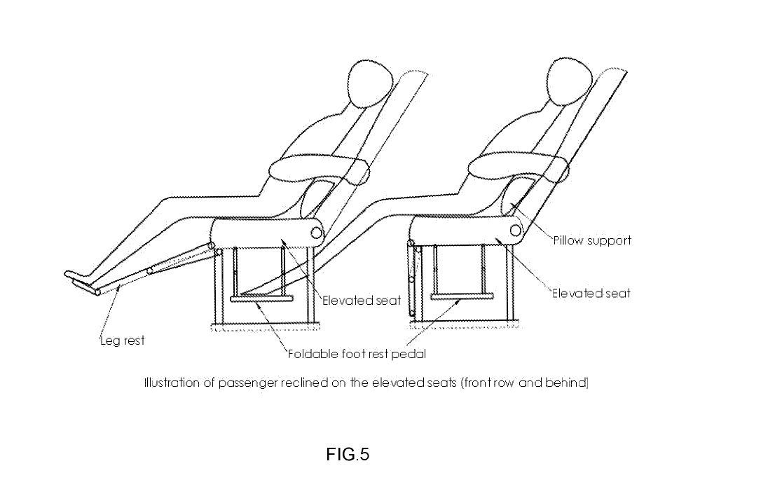

FIG. 6 shows a detail view of an elevated seat with the maglev module embedded and the extra storage space under the elevated seat.

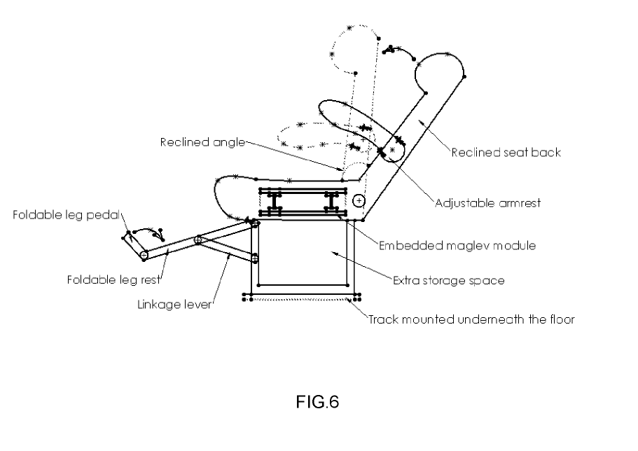

FIG. 7 shows a detail structure of a track-based elevated seat with foldable foot pedal, leg supporting gear and armrest.

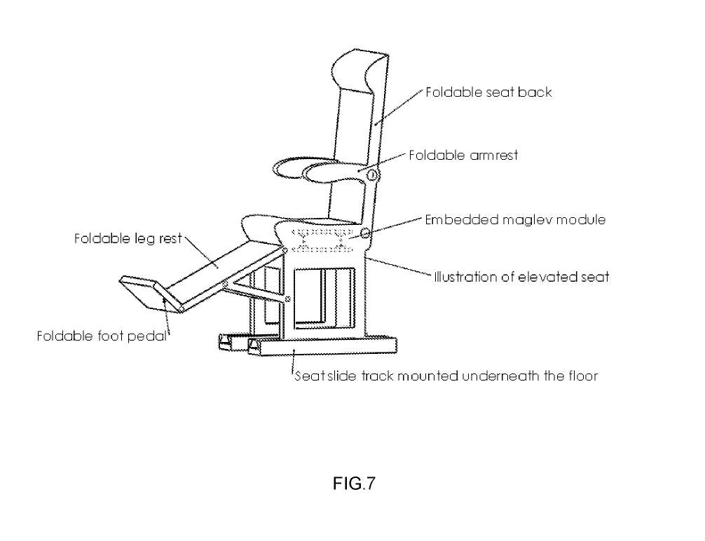

FIG. 8 shows a detailed view of the sliding track of the elevated seat.

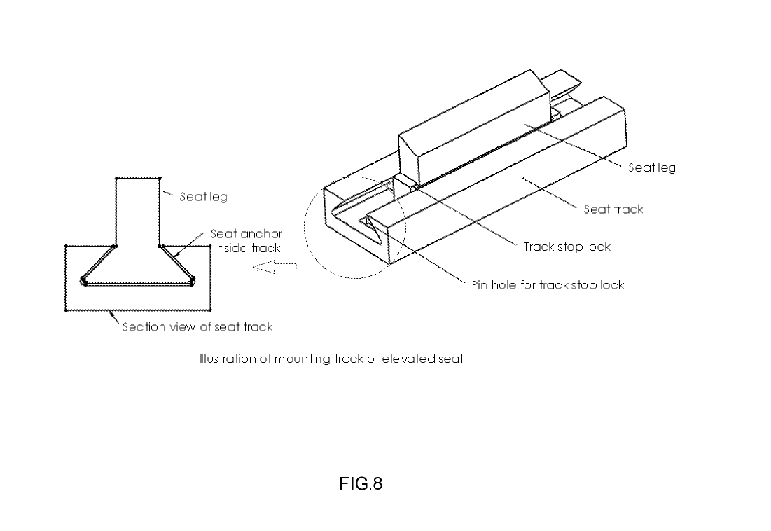

FIG. 9 shows passengers exercise using the multi-function maglev module in sitting and standing mode.

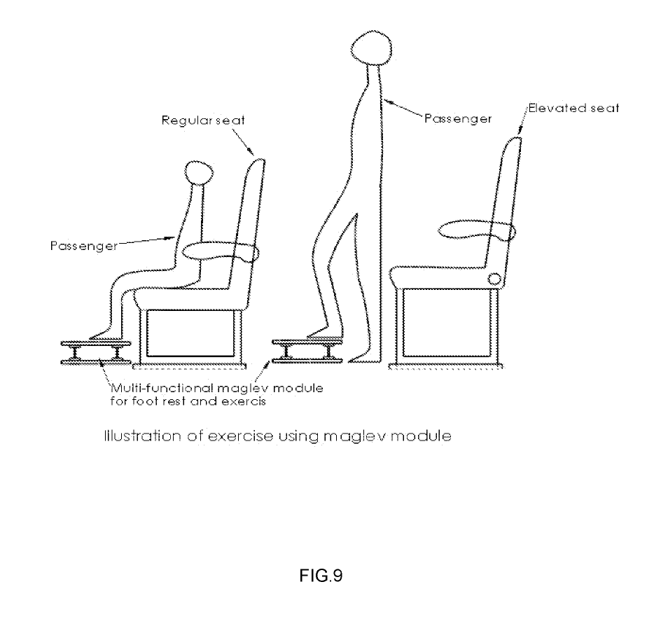

What is claimed is:

1. An aircraft seating arrangement is designed as one using track-based elevated seat that is placed in any position of any row of seats, wherein the track-based elevated seat is positioned higher than its adjacent seat(s).

2. The plurality of aircraft seats arrangement of claim 1 wherein the track-based elevated seats are mounted in any location and number in a given cabin.

3. The plurality of aircraft seats arrangement of claim 1 wherein the track-based elevated seats are elevated above the adjacent seats in the vertical range of ten to forty inches. The armrest of the elevated seat is optional in its height adjustment.

4. The plurality of aircraft seats arrangement of claim 1 wherein the track-based elevated seats pitch are increased in the range of three to ten inches from the original pitch of the given row in a given cabin class.

5. The plurality of aircraft seats arrangement of claim 1 wherein the linear distance from head to toe of the passenger on the track-based elevated seat is up to seventy-one inches while passenger on the seat is in the reclined mode.

6. The aircraft seats arrangement of claim 1 wherein our Maglev module is assembled into the track-based elevated seat and passengers can have safe and modest on-board exercise using it to relax and refresh.

7. Where the plurality of the maglev module of claim 6 is incorporated into the track-based elevated seats and accessible to passengers around it.
